(19) United States
(12) Patent Application Publication
(10) Pub. No.: US 2012/0210860 A1
(43) Pub. Date: Aug. 23, 2012

(54) Pipe-shaped product with ballistic protection

(76) Inventor: Jan Falck-Schmidt, Odense (DK)

(21) Appl. No.: 12/803,041

(22) Filed: Jan. 25, 2011

(30) Foreign Application Priority Data
Jan. 25, 2010 (DK) PA 2010 70022

(51) Int. Cl. F41H 5/02; B32B 37/14; F41H 5/06

(52) U.S. Cl. 89/36.02; 89/36.07; 156/184; 89/908; 89/929

(57) ABSTRACT

The present invention concerns a fibre composite product with embedded ballistic protection with at least one layer of reinforced fibres which are arranged by fibre filament windings and forms a pipe-shaped fibre composite product. Such pipe-shaped fibre composite product is typical circular pipe-shaped; however may also be oval or even angular. Simultaneously such fibre composite product is essentially suitable for use in different constructions where it is desired to built-in armouring elements, including the body of the vehicles, for instance in military vehicles. In connection with manufacturing military vehicles attempts are made to reduce the weight of the vehicles compared to the load capacity of the vehicles.

### FIELD OF THE INVENTION

The present invention relates to a method for making a fibre composite product with embedded ballistic protection, where the ballistic protection substantially is embedded between at least two layers of reinforced fibres, where these fibres are consolidated with a bonding material. Moreover, the invention relates to a fibre composite product with embedded ballistic protection made with the method in question and the use of such fibre composite product.

### BACKGROUND OF THE INVENTION

A number of different products and method are known where ballistic protection in form of ceramic material is embedded in, as an example, fibre composite products. Such fibre composite products are typically and as an example used in connection with personnel armour and vehicles and gives depending on the thickness and structure of the armouring a certain protection against shots from small arms, guns and missiles. A similar protection has through times been obtained by using steel plates having a sufficient thickness. However, the disadvantage of steel armouring is that it is heavy which may have a negative impact on the ability of the manoeuvring of the vehicle and besides makes the transportation of the vehicle difficult. Accordingly, it is desirable to use a less heavy form of armour.

Such fibre composite products having ballistic protection are typically manufactured by using known composite casting techniques and by using e.g. carbon fibres or glass fibres coated with bonding material, typically polyester, epoxy, vinyl ester or another suitable polymer. Hardening of the product may for some bonding materials take place without heating while other products requires temperature increase in an oven or autoclave.

An armouring according to known methods is especially suitable for plane surfaces as the used ceramic materials are plane. From U.S. Pat. No. 6,408,733 B1 composite products having a more complex shape are known where ballistic protection is embedded in the form of ceramic materials where each ceramic material is manufactured by casting especially to the actual place in the composite product. Obviously this is an expensive process as a substantial effort is required during the production of the ceramic products and further with arranging the different and specialized ceramic materials exactly on the right place in the construction.

Finally, also fibre composite products are known having a ballistic protection which is only made of different fibre materials, including carbon fibres, glass fibres and aramid fibres. Such solution is known from WO 2008/128708 A1 in which is described a method for manufacturing helmets having ballistic protection.

None of the known methods and products are suitable for use on pipe-shaped products and in order to comply with a wish to make a sufficient ballistic protection and efficiency of resistance on products for instance on products which constitute parts of a vehicle it is necessary having a product suitable for that purpose and having a new method in order to achieve this product.

### OBJECT OF THE INVENTION

It is the object of the present invention to provide a product and a method for manufacturing a fibre composite product, where a suitable ballistic protection of a pipe-shaped product is obtained, where the pipe-shaped product is suitable mainly for machine manufacturing, where subsequent processing is possible and preferably for building together with other products in a larger construction.

### DESCRIPTION OF THE INVENTION

This object is achieved with a method as mentioned in the introduction where manufacturing of a fibre composite product having embedded ballistic protection according to the invention includes at least one layer of the reinforced fibres which is arranged with fibre filament winding and forms a pipe-shaped fibre composite product. Such pipe-shaped fibre composite product is typical circular pipe-shaped; however may also be oval or even angular. There is, however, special advantages having a fibre composite product without edges, as the individual fibres in this way are used more optimum as no edges necessitate a more or less sharp bending of the fibres. Accordingly, it is possible to obtain a very strong and robust construction at the same time as the desired ballistic assurance due to the embedded protection is obtained.

Simultaneously such fibre composite product is essentially suitable for use in different constructions where it is desired to built-in armouring elements, including the body of the vehicles, for instance in military vehicles. In connection with manufacturing of military vehicles attempts are made to reduce the weight of the vehicles compared to the load capacity of the vehicles. Low weight is desirable/necessary in order to transport the vehicles by air. Simultaneously, good armouring is required. Conventional armoured vessels, including vehicles, are mainly built of armoured steel for protection and cargo-carrying capacity, however resulting in a high net weight and reduced mobility. In this way, great advantages exist by using fibre composite products in connection with such vehicles. Not only to make the plane panels on for example a light armoured vehicle having light fibre composite products but now also the pipe-shaped parts simultaneously with an optimal ballistic protection an improved security is obtained and a still lower total weight on the vehicle.

A fibre composite product with embedded protection according to the invention may advantageously be used such that the pipe-shaped fibre composite product forms a tower of a tower element on a vehicle, preferably a tower, which is arranged with means for lifting and lowering the tower where on the tower a weapon, sensors or other surveillance equipment and/or defence equipment is mounted. Such tower is regardless of which equipment is mounted an exposed construction part which a possible opponent may expect to try to hit or neutralize. To ensure a good and reliable functioning of the tower and a good protection of the equipment, for example electrically or electronic equipment which are mounted inside the tower element it is important that the tower is produced in such a way that it to some extent may withstand attacks from different means of attack.

In another use of a fibre composite product with embedded protection according to the invention the pipe shaped fibre composite product is used at least as a part of a mast, preferably a mast on a vehicle, where the mast is an extendable telescopic mast comprising a number of mast sections, where at least one of the section of the mast on the part of the mast which is visible when the mast is extended is totally or partly with embedded ballistic protection. Roughly there is no great difference whether it is a mast or a tower of a vehicle, but a mast shall in this situation also be regarded as a unit that may not be mounted on a vehicle. A mast comprising a fibre composite product with a ballistic protection according to the invention may be used for various unspecified purposes.

In a variant of a method for making a fibre composite product according to the invention the method comprises at least the following steps: arranging of a first layer of reinforced fibres, arranging of at least one layer of ballistic protection, preferably consisting of ceramic material and arranging of at least one second layer of reinforced fibres. With this method for making a fibre composite product a flexibility is achieved, that the first layer of reinforced fibres may have a first set of material properties, as the fibres may be carbon fibres that provide the required stiffness and strength in the fibre composite product, while the other layer of fibre reinforced fibres may have the same material properties or other material properties, for example glass fibres, as such fibres may suffice or may even better ensure that the layer or layers of ballistic protection is fixated in the correct location.

A method for making a fibre composite product according to the invention may comprise different embodiments and the pipe-shaped fibre composite product may be produced with one first internal layer of reinforced fibres, where said first layer is produced by lay-up of fibres arranged in mats or with another layer that is produced by fibre filament winding.

It is however also possible to produce the pipe-shaped fibre composite product with one first internal layer of reinforced fibres, where said layer is produced by fibre filament winding and with a second layer that is produced by lay-up of fibre arranged in mats.

Finally it is also possible that the pipe-shaped fibre composite product is produced with one first internal layer of reinforced fibres and with a second layer of reinforced fibres, where at least both layers are produced by fibre filament winding.

In this context the term mats shall also be understood as a web of fibres, where the fibres for example is arranged within these mats as rovings that extend mainly in one direction or in multible direction, where these directions may be at different angles in relation to each other and where said mats may be woven or stitched mats or even comprising short or long fibres that are orientated randomly in relation to each other. Such mats may have a width, which essentially corresponds to the length of the product, but may also be narrow mats in the form of tape having a width of for example 10-200 millimetres, but preferably having a width of 50-100 millimetres, where the tape are wound onto the fibre composite product using a technique that is comparable to fibre filament winding with the difference, that within these mats a given proportion of fibres that are not orientated in the longitudinal direction of the tape/roving. The term fibre filament winding must in this context be regarded as a process, where rovings of fibres and/or woven or stitched narrow bands of fibres are wound about a mandrel in a defined pattern, wherein it is possible to produce product of fibre where the fibres are arranged with defined angles in relation to the rotational axis of the product.

The choice of fibre material as well as the fibre material being rovings, mats or tape is made as needed and may be combined to achieve optimum strength, stiffness and ballistic protection. Hence there are advantages by application of mat shaped materials for example in the form of tape, as these due to the random fibre directions provides a significantly smaller effect on the construction, in case a shot penetrates the ballistic protection. Hence there arises only little damage, as the exit hole due to the random close-knit fibres/fibre directions does not spread as a crack in the construction, but rather remains a bound damage, for which reason the functioning of the construction is not necessarily significantly upset. At the same time there are certain other advantages of the application of for example fibre rovings and these advantages may according to the invention readily be combined with the advantages of other types of fibres and fibre materials.

In a preferred variant of the method for making a fibre composite product according to the invention the method further comprise steps where one or more layers of reinforced fibres are processed before or after arranging of one or more layers of ballistic protection. Hence it is possible to maintain tight tolerances on the fibre composite product, as one by means of processing may ensure for example uniform material thickness or surface quality. If initially fibres are wound on a mandrel and these fibres are consolidated with a suitable bonding agent, this intermediate product may be processed to the wanted quality and the ballistic protection may be installed with precision and consequently high quality and uniformity. After installation of the ballistic protection this may also be processed, or a second layer of reinforced fibres may be directly applied. This second layer may constitute a primary or secondary protection of the fibre composite product in relation to the first layer, as the layer may act as a stiffening or load carrying layer, but may also have an actual ballistic protective effect.

The invention concern as mentioned initially also a fibre composite product with ballistic protection made with a method as described above. The pipe-shaped fibre composite product according to the invention may preferably comprise an inner layer of consolidated fibres, one or more layers of ballistic protection, preferably in form of ceramic material, and further comprises at least one further layer of consolidated fibres, where the fibres preferably are glass fibres, carbon fibres and/or aramid fibres. Said fibres may be consolidated in a layer with a defined thickness and there may be applied different kinds of materials for fixating the ballistic protection to said layers of reinforced consolidated fibres. For example a vibration dampening material may be used, whereby it is ensured that an impacted sub element of the ballistic protection does not inflict damage on adjacent sub elements.

In a preferred embodiment of the fibre composite product with ballistic protection according to the invention the finished and cured fibre composite product may appear with processed surfaces and/or edges where these processed surfaces and/or edges are adapted for building together with further structural members. As mentioned above there may be referred to a pipe-shaped fibre composite product that shall be used as an extendable tower for a military vehicle. Typically such a tower is installed with a range of installations inside, and to enable the lifting and lowering of the tower in relation to the vehicle it is required that the outer geometry of the tower is precisely adapted to the aperture in the vehicle wherein the tower is mounted. This opportunity to adapt the internal as well as the external geometry as well as the shape of the edges of the fibre composite product is very much present, as such a fibre composite product easily and effortlessly may be machined as well as manually processed, such that the required geometry is achieved.

In a variant of a fibre composite product with ballistic protection according to the invention the ballistic protection may be constituted of ceramic materials having a thickness, a width and a length where at least the length is two or more times greater than the width. It may also be possible to carry out the invention by the use of ceramic materials that are more or less quadratic or with another shape, which is not elongated. There may for example be used materials which are angular as well as material having concave or convex side surfaces and of course combinations of the aforementioned.

In a preferred embodiment a fibre composite product with ballistic protection according to the invention the ballistic protection may comprise one or more layers of ceramic sticks, where the sticks are arranged and preferably fixed to a first layer of fibre composite, where said ceramic sticks are arranged directly or indirectly and adjacent and possibly end to end with staggered connections on the first layer of fibre composite. Such ceramic sticks or products may be arranged along or across the longitudinal axis of the fibre composite product. For example the ceramic products may constitute long sticks with a thickness and a width of approximately 25 millimetres and a length of up to 500 millimetres or more, where said sticks comprise two opposite and essentially parallel surfaces and with to other surfaces, where said other surfaces are angled such that a cross section of a ceramic product appears with a frustum shaped cross section. There can as mentioned be ceramic sticks or products that are shaped for primarily being arranged in the circumferential direction of the pipe-shaped fibre composite product as well as in the longitudinal direction of the product.

To improve the ballistic protection a fibre composite product with embedded ballistic protection according to the invention may be achieved such that the ballistic protection comprises two or more layers of ceramic material, where the individual ceramic materials in the individual layers preferably are arranged with an overlap in relation to the ceramic materials in a second layer. Improved safety is hereby achieved, as a given local area on such a fibre composite product may resist even more shots before the ballistic protection in the form of ceramic products is broken by said shots.

### DESCRIPTION OF THE DRAWING

In the following the invention is explained further with reference to the accompanying drawing, wherein

FIG. 1 shows a cross section of a fibre composite product with ballistic protection, yet having only one inner layer of reinforced fibres.

FIG. 2 shows a cross section of a fibre composite product having ballistic protection.

FIG. 3 shows a cross section of a fibre composite product having two layers of ballistic protection.

### DETAILED DESCRIPTION OF THE INVENTION

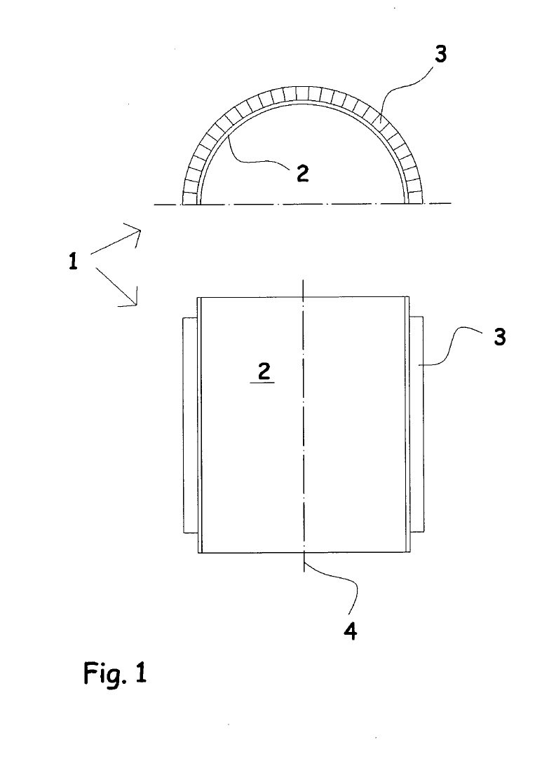

In FIG. 1 two different sectional drawings of a fibre composite product 1 having ballistic protection are seen. One picture which shows an intersected product 1 seen from the end, and one picture which shows the same intersected product 1 seen from the side. Innermost in the fibre composite product 1 a first layer 2 of reinforced fibres is seen. This fibre layer 2 may advantageously be built with fibre filament winding but may also be produced by providing and consolidation of mats of fibres. Externally on this fibre layer 2 a number of ceramic materials 3 are seen which constitute the ballistic protection. These ceramic materials 3 are made from known materials for this purpose. In this variant of the invention a number of the ceramic materials 3 are arranged side by side in the longitudinal direction of the fibre composite product 1, as the figure shows a fibre composite product 1 which is rotary symmetrical round the longitudinal axis 4. These ceramic materials 3 may be fixated to the fibre layer 2 by using different not further specified types of adhesives or glue. As seen from FIG. 1 the ceramic materials 3 are closely arranged side by side in order to produce the necessary support and stability in the construction.

The ceramic materials 3 are here shown with two parallel surfaces—one surface which faces the fibre layer 2 and a second surface which turns away from the first fibre layer 2. The remaining two sides are made with a bevel corresponding to the part the product 3 takes up on the periphery of the fibre layer 2. Thus it is possible to obtain a sufficient and good tolerance between the individual ceramic materials 3. In order to obtain an optimum tolerance it may be necessary to process the outer surface on the fibre layer 2 in such a way that the diameter exactly corresponds to the bevel which is on the side faces of the ceramic materials. In the shown variant the ceramic materials 3 are in full length, however, they may as a matter of course and in some constructions with advantage be shorter and with a butt joint in the longitudinal direction in such a way that two or several ceramic materials 3 are arranged in a row.

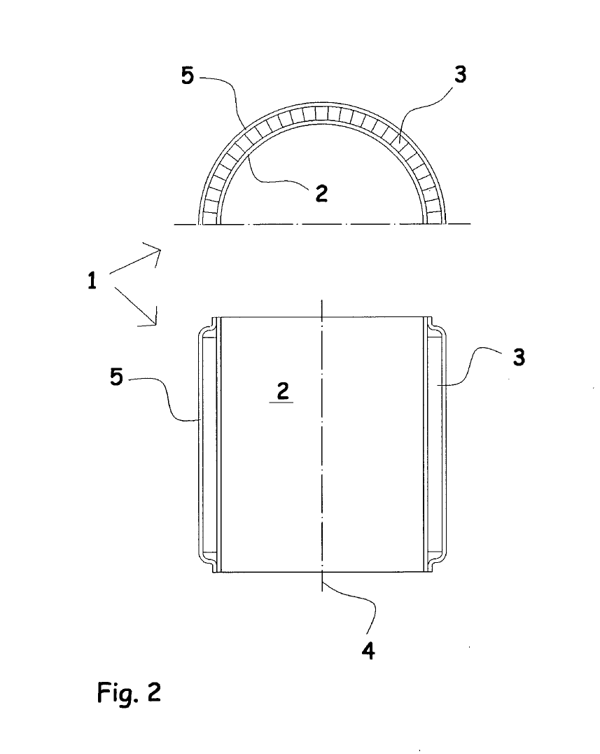

In FIG. 2 a fibre composite product 1 as in FIG. 1 is shown, however, with the second fibre layer 5 arranged on the outside of the layer of ceramic materials 3. Before this fibre layer 5 is arranged a process of the outer surface on the adjacent ceramic materials 3 may be performed whereby a more circular product is obtained, as the surface otherwise appears as a polygon. When the second fibre layer 5 is formed and consolidated also this fibre layer as well as the ends of the fibre composite product 1 may be processed and adapted according to the actual needs and wishes.

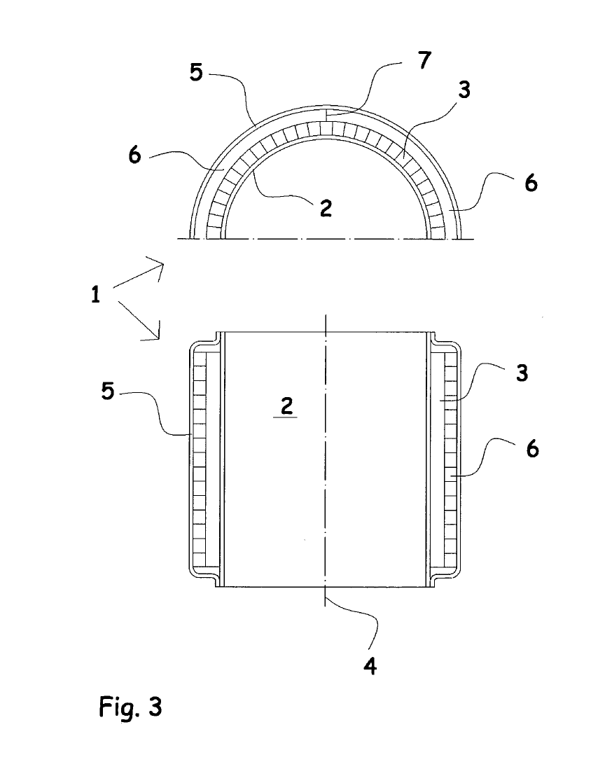

Finally, in FIG. 3 a variant of a fibre composite product 1 with ballistic protection is seen, where a further layer of ceramic materials 6 is arranged. These ceramic materials 6 are here shown as materials arranged transverse to the previous mentioned ceramic materials 3. In the shown variant reference is made to ceramic materials 6 having a rectangular cross section and having a curvature corresponding to the outer diameter on the first layer of ceramic materials 3. In such variant processing of the first layer of ceramic materials 3 may be performed in such a way that the curvature on the first layer and the second layer fits exactly. Alternative an intermediate layer may be provided between the two layers, which intermediate layer takes up overlapping inaccuracies. Outside the second layer of ceramic materials 6 a second and reinforcing fibre layer 5 is provided, see also FIG. 2.

The fibres in the first layer 2 as well as in the second layer 5 may be of the same type, however different fibre types may be used and fibres which are arranged in rovings, in different types of mats depending on the properties wanted both with regard to ballistic protection and with regard to stiffness and strength in the construction for that matter.

1. Method for making a fibre composite product with embedded ballistic protection, where the ballistic protection substantially is embedded between at least two layers of reinforced fibres, where these fibres are consolidated with a bonding material, characterized in that at least one layer of the reinforced fibres is arranged with fibre filament winding and forms a pipe-shaped fibre composite product.

2. Method for making a fibre composite product according to claim 1, characterized in that the method at least comprises the following steps: arranging of a first layer of reinforced fibres, arranging of at least one layer ballistic protection, preferably consisting of ceramic material and arranging of at least one second layer of reinforced fibres.

3. Method for making a fibre composite product according to claim 1 and 2, characterized in that the pipe-shaped fibre composite product is made with one first inner layer of reinforced fibres, where said first layer is produced by providing fibres arranged in mats and with a second layer which is produced by fibre filament winding.

4. Method for making a fibre composite product according to claim 1 and 2, characterized in that the pipe-shaped fibre composite product is made with one first inner layer of reinforced fibres, where the layer is produced by fibre filament winding and with a second layer which is produced by providing fibres arranged in mats.

5. Method for making a fibre composite product according to claim 1 and 2, characterized in that the pipe-shaped fibre composite product is made with one first inner layer of reinforced fibres and with a second layer of reinforced fibres, where at least both layers are produced by fibre filament winding.

6. Method for making a fibre composite product according to any of claims 1-5, characterized in that the method further comprises steps where one or more layers of reinforced fibres are processed before or after arranging of one or more layers of ballistic protection.

7. Fibre composite product with embedded ballistic protection made with a method according to any of claims 1-6, characterized in that the pipe-shaped fibre composite product comprises an inner layer of consolidated fibres, one or more layers of ballistic protection, preferably in form of ceramic material, and further comprises at least one further layer of consolidated fibres, where the fibres preferably are glass fibres, carbon fibres and/or aramid fibres.

8. Fibre composite product with embedded ballistic protection according to claim 7, characterized in that the finished and cured fibre composite product appears with processed surfaces and/or edges where these processed surfaces and/or edges are adapted for building together with further structural members.

9. Fibre composite product with embedded ballistic protection according to any of claims 7 and 8, characterized in that the ballistic protection is constituted of ceramic materials having a thickness, a width and a length where at least the length is two or more times greater than the width.

10. Fibre composite product with embedded ballistic protection according to any of claims 7-9, characterized in that the ballistic protection comprises one or more layers of ceramic sticks, where the sticks are arranged and preferably fixed to a first layer of fibre composite, where the ceramic sticks are arranged directly or indirectly and adjacent and possibly end to end with staggered connections on the first layer of fibre composite.

11. Fibre composite product with embedded ballistic protection according to any of claims 7-10, characterized in that the ballistic protection comprises two or more layers of ceramic material, where the individual ceramic materials in the individual layers preferably are arranged with an overlap in relation to the ceramic materials in a second layer.

12. Use of fibre composite product with embedded protection according to any of claims 7-11, characterized in that the pipe-shaped fibre composite product is used as a tower on a vehicle, preferably a tower, which is arranged with means for lifting and lowering the tower, where on the tower a weapon, sensors or other surveillance equipment and/or defence equipment is mounted.

13. Use of fibre composite product with embedded protection according to any of claims 7-11, characterized in that the pipe-shaped fibre composite product is used at least as a part of a mast, preferably a mast on a vehicle, where the mast is an extending telescopic mast comprising a number of mast sections, where at least one of the sections of the mast on the part of the mast which is visible when the mast is extended is totally or partly with embedded ballistic protection.
